(19) United States
(12) Patent Application Publication
(10) Pub. No.: US 2020/0136474 A1
(43) Pub. Date: Apr. 30, 2020

(54) ELECTRIC MOTOR WITH NAVIGATIONAL LIGHT

(71) Applicant: STOLLMEYER TECHNOLOGIES, LLC, San Luis Obispo, CA (US)

(72) Inventors: MARCUS RICHARD STOLLMEYER, SANTA MARIA, CA (US); JOSEPH RILEY COPLON, SAN LUIS OBISPO, CA (US)

(21) Appl. No.: 16/177,242

(22) Filed: Oct. 31, 2018

(51) Int. Cl. H02K 11/00; B64C 39/02; H02K 15/14; H05B 37/02

(52) U.S. Cl. CPC H02K 11/0094; B64C 39/024; B64C 2201/042; H05B 37/0245; H02K 15/14

(57) ABSTRACT

A motor unit system with a navigational light is described. The motor unit system includes a housing with a circular cross-section and mounting holes on one end of the housing, and a brushless direct current motor comprising a shaft and a winding. The shaft may extend from inside the housing to outside of the housing through a hole at the one end of the housing or at another opposite end of the housing. The winding may be contained within the housing, and a light source may also be contained within the housing. An opening in the housing is adapted to allow light from the light source to exit the housing.

This application relates to the following applications filed concurrently herewith. The related applications, all of which are incorporated herein by reference, are:

Attorney Docket No. 20966-143350-US, U.S. patent application Ser. No. ______, of Stollmeyer, et al., entitled ELECTRIC MOTOR WITH AN INTEGRAL MOTOR CONTROLLER;

Attorney Docket No. 20966-143351-US, U.S. patent application Ser. No. ______, of Stollmeyer, et al., entitled ELECTRIC MOTOR WITH INTEGRATED MOTOR CONTROLLER; and

Attorney Docket No. 20966-143352-US, U.S. patent application Ser. No. ______, of Stollmeyer, et al., entitled ELECTRIC MOTOR WITH SENSORS.

### BACKGROUND OF THE INVENTION

### 1. Field of the Invention

The present invention relates generally to an electric motor, and more specifically to an electric motor that incorporates a navigation light.

### 2. Discussion of the Related Art

Various systems and processes are known in the art for powering a propulsion system. For example, a propulsion system for an unmanned vehicle may include an electric motor. An unmanned vehicle may also have a navigation lighting system that enables line-of-sight viewing, especially in dark conditions.

However, in some cases adding a separate navigation lighting system to an unmanned vehicle may be inconvenient and may introduce additional components that add complexity and impair the functioning of the vehicle.

### SUMMARY

A motor unit system is described. The motor unit system may include a housing comprising a circular cross-section and further comprising a plurality of mounting holes on one end of the housing, a brushless direct current motor comprising a shaft and a winding, the shaft extending from inside the housing to outside of the housing through a hole at the one end of the housing, at another end of the housing or both, the other end of the housing being opposite the one end of the housing, the winding being contained within the housing, a light source contained within the housing, and an opening adapted to allow light from the light source to exit the housing.

An unmanned vehicle is described. The unmanned vehicle may include a frame, one or more propulsion units, and a motor unit system, the motor unit system including a housing comprising a circular cross-section and further comprising a plurality of mounting holes on one end of the housing, a brushless direct current motor comprising a shaft and a winding, the shaft extending from inside the housing to outside of the housing through a hole at the one end of the housing, at another end of the housing or both, the other end of the housing being opposite the one end of the housing, the winding being contained within the housing, a light source contained within the housing, and an opening adapted to allow light from the light source to exit the housing.

A method of manufacturing a motor unit system is described. The method may include providing a housing comprising a circular cross-section and further comprising a plurality of mounting holes on one end of the housing, providing a brushless direct current motor comprising a shaft and a winding, the shaft extending from inside the housing to outside of the housing through a hole at the one end of the housing, at another end of the housing or both, the other end of the housing being opposite the one end of the housing, the winding being contained within the housing, providing a light source contained within the housing, and providing an opening adapted to allow light from the light source to exit the housing.

Some examples of the motor unit system, unmanned vehicle, and method described above may further include a light-transmissive piece positioned in the opening comprising a portion continuous with the circular cross-section. In some examples of the motor unit system, unmanned vehicle, and method described above, the light source is optically coupled to the light-transmissive piece.

Some examples of the motor unit system, unmanned vehicle, and method described above may further include a light control contained within the housing, the light control coupled to the light source and to a connector adapted to connect the light control to an external controller to receive control signals from outside the housing from the external controller.

In some examples of the motor unit system, unmanned vehicle, and method described above, said light source is adapted to produce a first light color in response to a first signal from said light control and is adapted to produce a second light color in response to a second signal from said light control. In some examples of the motor unit system, unmanned vehicle, and method described above, said light source is adapted to produce a first blinking pattern in response to a first signal from said light control and is adapted to produce continuous light in response to a second signal from said light control.

Some examples of the motor unit system, unmanned vehicle, and method described above may further include a motor controller contained within the housing, the motor controller coupled to the motor.

In some examples of the motor unit system, unmanned vehicle, and method described above, said housing comprises removable bottom cover wherein the removable bottom cover comprises said mounting holes. In some examples of the motor unit system, unmanned vehicle, and method described above, said removable bottom cover comprises a notch, said light-transparent piece covering the notch, wherein the notch permits light from the light source to exit the one end of the housing.

In some examples of the motor unit system, unmanned vehicle, and method described above, the notch has a width of at least 45 degrees of the circumference of the removable bottom cover and the housing. In some examples of the motor unit system, unmanned vehicle, and method described above, the notch has a width of at least 80 degrees of the circumference of the removable bottom cover and the housing.

In some examples of the motor unit system, unmanned vehicle, and method described above, said light-transparent piece comprises a portion co-planar with the one end of the housing.

### BRIEF DESCRIPTION OF THE DRAWINGS

FIG. 1 shows an example of a perspective view of a motor unit system of an unmanned vehicle in accordance with aspects of the present disclosure.

FIG. 2 shows an example of a front view of a motor unit system in accordance with aspects of the present disclosure.

FIG. 3 shows an example of a side view of a motor unit system in accordance with aspects of the present disclosure.

FIG. 4 shows an example of a bottom view of a motor unit system in accordance with aspects of the present disclosure.

FIG. 5 shows an example of an exploded view of a motor unit system in accordance with aspects of the present disclosure.

FIG. 6 shows an example of a schematic of a motor unit system with a navigational light in accordance with aspects of the present disclosure.

FIG. 7 shows an example of a process for manufacturing a motor unit system in accordance with aspects of the present disclosure.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

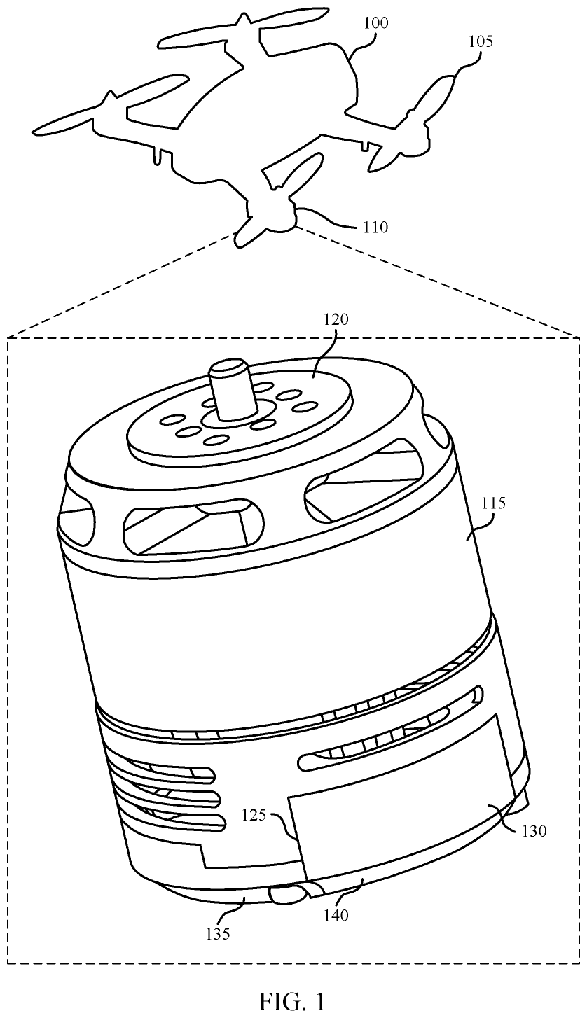

FIG. 1 shows an example of a perspective view of a motor unit system 110 of an unmanned vehicle 100 in accordance with aspects of the present disclosure. In some embodiments, the motor unit system 110 may be combined with other components to produce an unmanned aerial vehicle (UAV), such as unmanned vehicle 100. However, this is just one application of the motor unit system 110, which may also be incorporated into devices other than unmanned vehicle 100.

By combining a motor 120 with a light source and an electronic speed control (ESC), the motor unit system 110 may enable faster and easier assembly as well as more robust performance. Some embodiments may be used in conjunction with a connector system that enables quick assembly without soldering. In some cases, the motor unit system 110 may also include a built-in direction switch and nav light switch.

The motor unit system 110 may also be configured with elements that enable durable and reliable performance in a variety of flight conditions. For example, an internal ESC may be conformally coated to protect the motor unit system 110 from damage in wet conditions.

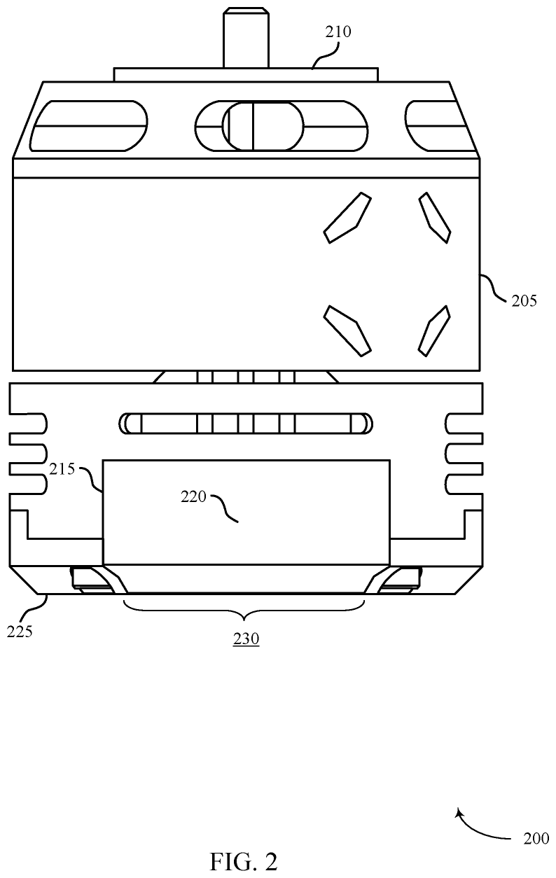

Unmanned vehicle 100 may include propulsion unit 105 and motor unit system 110. Motor unit system 110 may be an example of, or include aspects of, the corresponding elements described with reference to FIGS. 2-6. Motor unit system 110 may include housing 115, motor 120, opening 125, panel 130, bottom cover 135, and notch 140.

Housing 115 may include a circular cross-section and a plurality of mounting holes on one end. In some examples, the housing 115 comprises a removable bottom cover 135 wherein the removable bottom cover 135 comprises the mounting holes. Housing 115 may be an example of, or include aspects of, the corresponding elements described with reference to FIGS. 2, 3, and 5.

Motor 120 may comprise a shaft and a winding, the shaft extending from inside the housing 115 to outside of the housing 115 through a hole at the one end of the housing 115, at another end of the housing 115 or both, the other end of the housing 115 being opposite the one end of the housing 115. The winding may also be contained within the housing 115. Motor 120 may be an example of, or include aspects of, the corresponding elements described with reference to FIGS. 2, 3, 5, and 6.

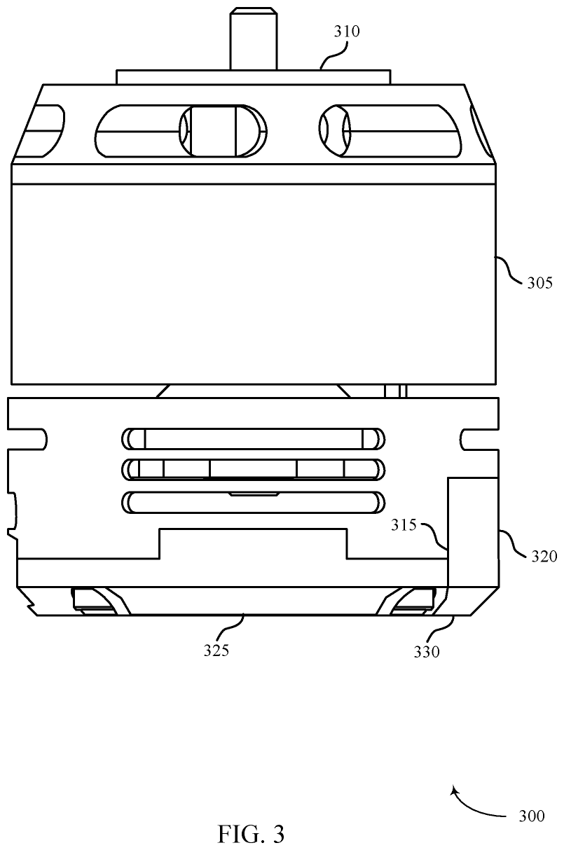

Opening 125 may be adapted to allow light from the light source to exit the housing 115. Opening 125 may be an example of, or include aspects of, the corresponding elements described with reference to FIGS. 2 and 3.

Panel 130 may be an example of a light-transmissive piece positioned in the opening 125 comprising a portion continuous with the circular cross-section of the housing 115. In some examples, the panel includes a portion co-planar with the one end of the housing 115. Panel 130 may be an example of, or include aspects of, the corresponding elements described with reference to FIGS. 2 and 3.

In some examples, the housing 115 is connected to bottom cover 135. Bottom cover 135 may be removable, and may include a notch 140, where the panel 130 covers the notch 140, and where the notch 140 permits light from the light source to exit the one end of the housing 115. Bottom cover 135 may be an example of, or include aspects of, the corresponding elements described with reference to FIGS. 2-5.

In some examples, the notch 140 has a width of at least 45 degrees of the circumference of the removable bottom cover 135 and the housing 115. In some examples, the notch 140 has a width of at least 80 degrees of the circumference of the removable bottom cover 135 and the housing 115. Notch 140 may be an example of, or include aspects of, the corresponding elements described with reference to FIGS. 2-4.

FIG. 2 shows an example of a front view of a motor unit system 200 in accordance with aspects of the present disclosure. Motor unit system 200 may be an example of, or include aspects of, the corresponding elements described with reference to FIGS. 1, and 3-6. Motor unit system 200 may include housing 205, motor 210, opening 215, panel 220, bottom cover 225, and notch 230.

Housing 205 may be an example of, or include aspects of, the corresponding elements described with reference to FIGS. 1, 3, and 5. Motor 210 may be an example of, or include aspects of, the corresponding elements described with reference to FIGS. 1, 3, 5, and 6.

Opening 215 and panel 220 may be examples of, or include aspects of, the corresponding elements described with reference to FIGS. 1 and 3. Bottom cover 225 may be an example of, or include aspects of, the corresponding elements described with reference to FIGS. 1, and 3-5. Notch 230 may be an example of, or include aspects of, the corresponding elements described with reference to FIGS. 1, 3, and 4.

FIG. 3 shows an example of a side view of a motor unit system 300 in accordance with aspects of the present disclosure. Motor unit system 300 may be an example of, or include aspects of, the corresponding elements described with reference to FIGS. 1, 2, and 4-6. Motor unit system 300 may include housing 305, motor 310, opening 315, panel 320, bottom cover 325, and notch 330.

Housing 305 may be an example of, or include aspects of, the corresponding elements described with reference to FIGS. 1, 2, and 5. Motor 310 may be an example of, or include aspects of, the corresponding elements described with reference to FIGS. 1, 2, 5, and 6.

Opening 315 and panel 320 may be examples of, or include aspects of, the corresponding elements described with reference to FIGS. 1 and 2. Bottom cover 325 may be an example of, or include aspects of, the corresponding elements described with reference to FIGS. 1, 2, 4, and 5. Notch 330 may be an example of, or include aspects of, the corresponding elements described with reference to FIGS. 1, 2, and 4.

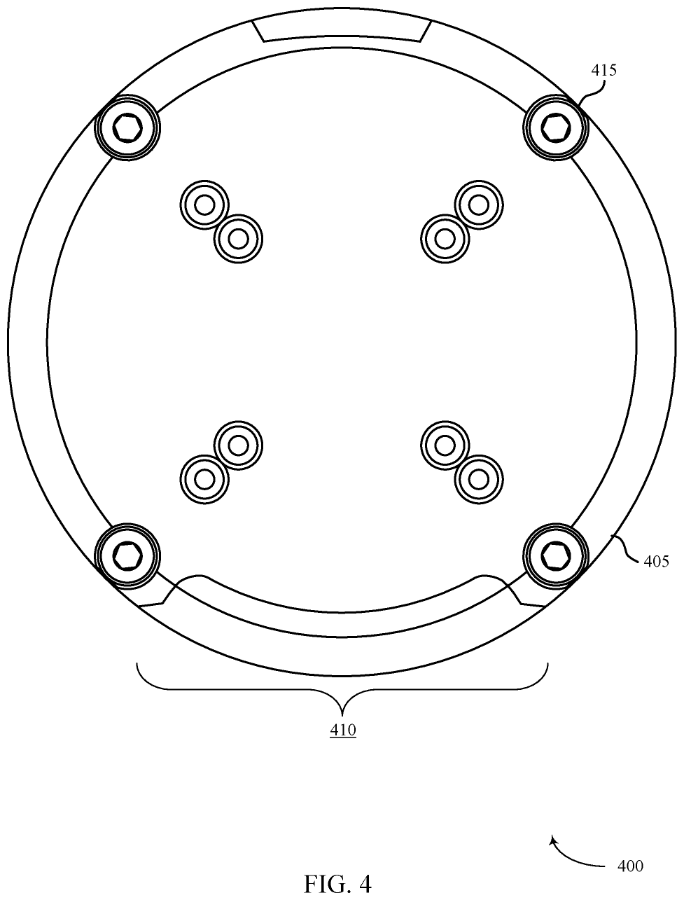

FIG. 4 shows an example of a bottom view of a motor unit system 400 in accordance with aspects of the present disclosure. Motor unit system 400 may be an example of, or include aspects of, the corresponding elements described with reference to FIGS. 1-3, 5, and 6. Motor unit system 400 may include bottom cover 405, notch 410, and mounting holes 415.

Bottom cover 405 may be an example of, or include aspects of, the corresponding elements described with reference to FIGS. 1-3, and 5. Notch 410 may be an example of, or include aspects of, the corresponding elements described with reference to FIGS. 1-3.

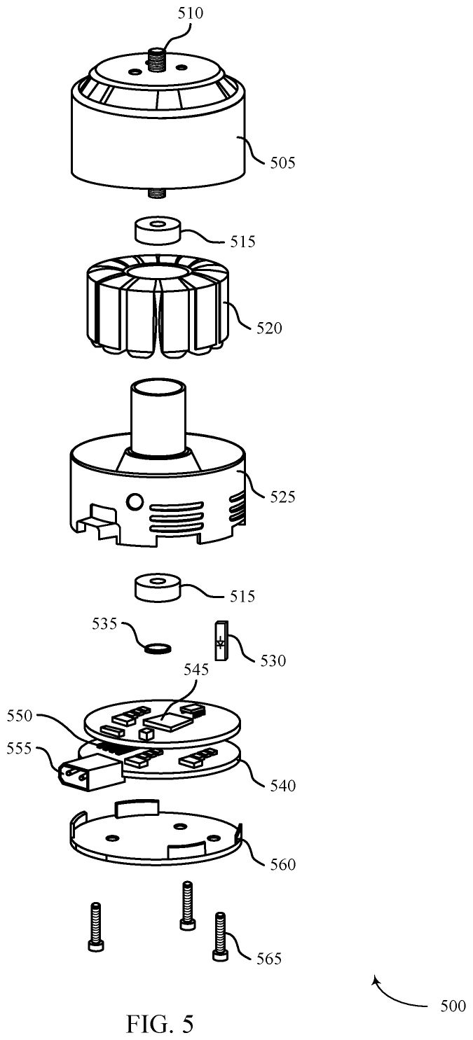

FIG. 5 shows an example of an exploded view of a motor unit system 500 in accordance with aspects of the present disclosure. Motor unit system 500 may be an example of, or include aspects of, the corresponding elements described with reference to FIGS. 1-4, and 6. Motor unit system 500 may include motor 505, shaft 510, ball bearing 515, coils 520, housing 525, light source 530, lock clip 535, circuit board 540, ESC 545, data input 550, power input 555, bottom cover 560, and fasteners 565.

In one embodiment, the motor 505 may operate at 3,515 revolutions per minute (RPM) and 500 kV. An example shaft 510 size may be 4 mm, and an example weight for the motor unit system 500 may be from 150-200 g. The input voltage range may be between 10V-25.5V.

In some examples, the motor unit system 500 may be used in conjunction with a battery power source. For example, the battery may be a 4 cell to 6 cell Lithium polymer (LiPo) battery with 14.8 v-22.2 v Continuous Current, and 20 Amps (500 W), with a burst current of 35 Amps. However, one skilled in the art will recognize that other battery systems may be suitable for power the motor unit system 500.

In some examples, the motor unit system 500 may be connected to a frame of a UAV, and may power a propulsion unit such as a propeller. For example, the propulsion unit for a multi-rotor vehicle may have a 12-inch to 15-inch Diameter, with a 3-inch to 5-inch pitch. For a fixed wing vehicle, the propulsion unit may have a 9-inch to 13-inch Diameter, with a 5-inch to 9-inch pitch. In one embodiment, the total vehicle weight for a multi-rotor vehicle may be up to 1.5 KG per motor 505. In some fixed wing embodiments, the total weight may be up to 4 KG per motor 505.

In some embodiments, the motor 505 may be powerful enough to lift wide array of vehicles and payloads and may be durable and reliable enough to perform in a wide variety of conditions.

In some examples, the ESC 545 may be pre-tuned for precision and efficiency, and may be conformally coated to increased reliability. The light source 530 may enable line-of-sight flying, and may greatly improve visibility, safety, and communications. By combining the light source 530 with the motor 505 unit, the vehicle and motor unit may achieve a desirable compact form factor.

In some examples, a switch on the back of the motor unit system 500 may allow a user to dictate the direction of the rotor rotation.

The motor unit system 500 may be configured with one or more solder-free connection points, so that the motor unit system 500 may be simply plugged into a vehicle. In some examples, the motor unit system 500 may include, or may be packaged with a pre-soldered cable and a connector system to connect the motor unit system 500 to a power input 555, a throttle input, and a propulsion unit.

Motor 505 may be an example of, or include aspects of, the corresponding elements described with reference to FIGS. 1-3, and 6. Housing 525 may be an example of, or include aspects of, the corresponding elements described with reference to FIGS. 1-3.

Light source 530 may be contained within the housing 525. In some examples, the light source 530 is optically coupled to the light-transmissive piece (e.g., the panel described with reference to FIGS. 1-3). The light source may be a variable color light source such as a red-green LED, or may be an array of independently colored LEDs, such as a red LED, a blue LED, and a green LED.

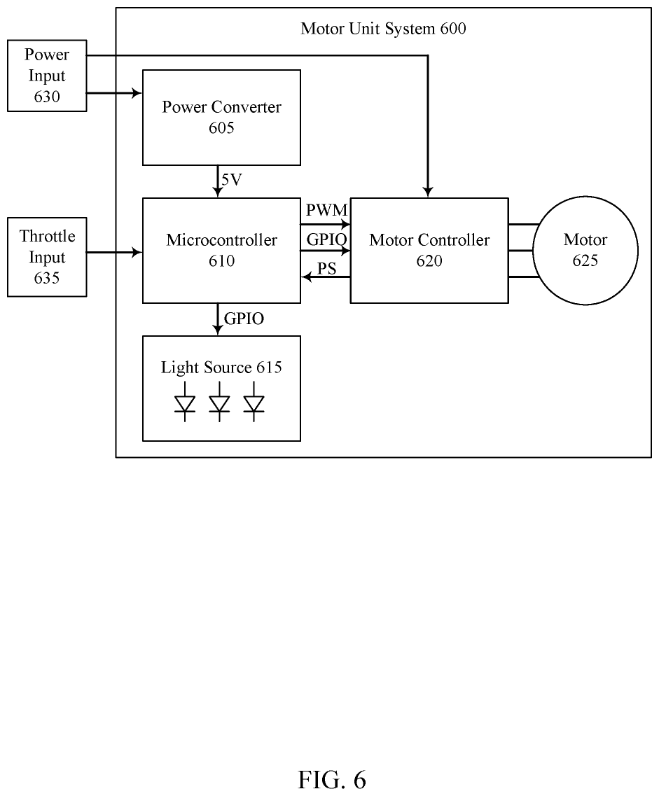

Light source 530 and power input 555 may be examples of, or include aspects of, the corresponding elements described with reference to FIG. 6. Bottom cover 560 may be an example of, or include aspects of, the corresponding elements described with reference to FIGS. 1-4.

FIG. 6 shows an example of a schematic of a motor unit system 600 with a navigational light in accordance with aspects of the present disclosure. The example shown includes motor unit system 600, power input 630, and throttle input 635.

Motor unit system 600 may be an example of, or include aspects of, the corresponding elements described with reference to FIGS. 1-5. Motor unit system 600 may include power converter 605, microcontroller 610, light source 615, motor controller 620, and motor 625. Light source 615 may be an example of, or include aspects of, the corresponding elements described with reference to FIG. 5. In one example, light source 615 may include one or more navigational light emitting diode (LED) components.

Power input 630 may provide power to power converter 605 and motor controller 620. Power converter 605 may convert the power (e.g., by adjusting the voltage from 10V-25V to 5V) for consumption by the microcontroller 610. Microcontroller 610 may provide general purpose input/output (GPIO) to light source 615. In one example, microcontroller 610 may include or represent a light control coupled to light source 615. Microcontroller 610 may also provide pulse width modulation (PWM) and GPIO to motor controller 620. Motor controller 620 may provide phase sense (PS) feedback to microcontroller 610.

Motor controller 620 may be contained within the housing, and may be coupled to the motor 625. In one example, the motor controller 620 is an ESC. Motor 625 may be an example of, or include aspects of, the corresponding elements described with reference to FIGS. 1-3, and 5. Power input 630 may be an example of, or include aspects of, the corresponding elements described with reference to FIG. 5.

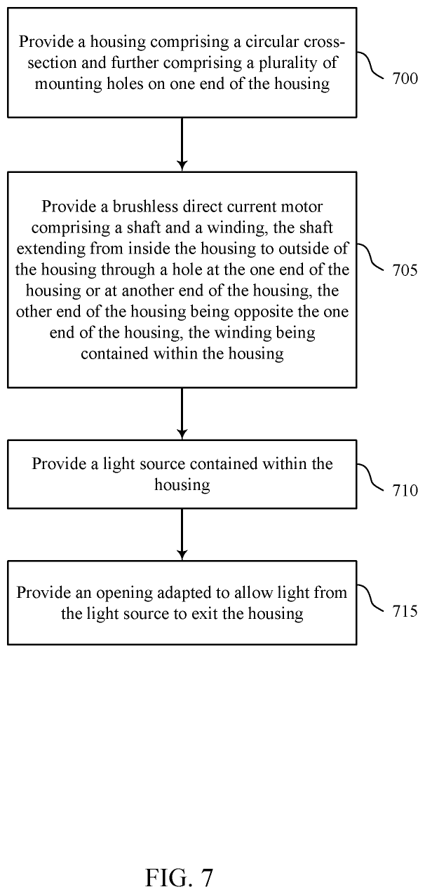

FIG. 7 shows an example of a process for manufacturing a motor unit system in accordance with aspects of the present disclosure. In some examples, these operations may be performed manually, or by a system with a processor executing a set of codes to control functional elements of a manufacturing apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 700, a manufacturing system may provide a housing comprising a circular cross-section and further comprising a plurality of mounting holes on one end of the housing. In some cases, the operations of this step may refer to a housing as described with reference to FIGS. 1-3, and 5.

At step 705, the manufacturing system may provide a brushless direct current motor comprising a shaft and a winding, the shaft extending from inside the housing to outside of the housing through a hole at the one end of the housing or at another end of the housing, the other end of the housing being opposite the one end of the housing, the winding being contained within the housing. In some cases, the operations of this step may refer to a motor as described with reference to FIGS. 1-3, 5, and 6.

At step 710, the manufacturing system may provide a light source contained within the housing. In some cases, the operations of this step may refer to a light source as described with reference to FIGS. 5 and 6.

At step 715, the manufacturing system may provide or form an opening in the housing adapted to allow light from the light source to exit the housing. In some cases, the operations of this step may refer to an opening as described with reference to FIGS. 1-3.

While the invention herein disclosed has been described by means of specific embodiments, examples and applications thereof, numerous modifications and variations could be made thereto by those skilled in the art without departing from the scope of the invention set forth in the claims.

What is claimed is:

1. A motor unit system, comprising:
a housing comprising a circular cross-section and further comprising a plurality of mounting holes on one end of the housing;
a brushless direct current motor comprising a shaft and a winding, the shaft extending from inside the housing to outside of the housing through a hole at the one end of the housing or at another end of the housing, the other end of the housing being opposite the one end of the housing, the winding being contained within the housing;
a light source contained within the housing; and
an opening adapted to allow light from the light source to exit the housing.

2. The motor unit system of claim 1, the motor unit system further comprising:
a light-transmissive piece positioned in the opening comprising a portion continuous with the circular cross-section; and
wherein the light source is optically coupled to the light-transmissive piece.

3. The motor unit system of claim 2, the motor unit system further comprising:
a light control contained within the housing, the light control coupled to the light source and to a connector adapted to connect the light control to an external controller to receive control signals from outside the housing from the external controller.

4. The motor unit system of claim 3, wherein:
said light source is adapted to produce a first light color in response to a first signal from said light control and is adapted to produce a second light color in response to a second signal from said light control.

5. The motor unit system of claim 3, wherein:
said light source is adapted to produce a first blinking pattern in response to a first signal from said light control and is adapted to produce continuous light in response to a second signal from said light control.

6. The motor unit system of claim 1, the motor unit system further comprising:
a motor controller contained within the housing, the motor controller coupled to the motor.

7. The motor unit system of claim 1, wherein:
said housing comprises removable bottom cover wherein the removable bottom cover comprises said mounting holes.

8. The motor unit system of claim 7, wherein:
said removable bottom cover comprises a notch, said light-transparent piece covering the notch, wherein the notch permits light from the light source to exit the one end of the housing.

9. The motor unit system of claim 8, wherein:
the notch has a width of at least 45 degrees of the circumference of the removable bottom cover and the housing.

10. The motor unit system of claim 8, wherein:
the notch has a width of at least 80 degrees of the circumference of the removable bottom cover and the housing.

11. The motor unit system of claim 1, wherein:
said light-transparent piece comprises a portion co-planar with the one end of the housing.

12. An unmanned vehicle comprising:
a frame;
one or more propulsion units;
a battery unit; and
a motor unit system, the motor unit system further comprising:
a housing comprising a circular cross-section and further comprising a plurality of mounting holes on one end of the housing;
a brushless direct current motor comprising a shaft and a winding, the shaft extending from inside the housing to outside of the housing through a hole at the one end of the housing or at another end of the housing, the other end of the housing being opposite the one end of the housing, the winding being contained within the housing;
a light source contained within the housing; and
an opening adapted to allow light from the light source to exit the housing.

13. The unmanned vehicle of claim 12, the unmanned vehicle further comprising:
a light-transmissive piece positioned in the opening comprising a portion continuous with the circular cross-section; and
wherein the light source is optically coupled to the light-transmissive piece.

14. The unmanned vehicle of claim 13, the unmanned vehicle further comprising:
a light control contained within the housing, the light control coupled to the light source and to a connector adapted to connect the light control to an external controller to receive control signals from outside the housing from the external controller.

15. The unmanned vehicle of claim 14, wherein:
said light source is adapted to produce a first light color in response to a first signal from said light control and is adapted to produce a second light color in response to a second signal from said light control.

16. The unmanned vehicle of claim 14, wherein:
said light source is adapted to produce a first blinking pattern in response to a first signal from said light control and is adapted to produce continuous light in response to a second signal from said light control.

17. The unmanned vehicle of claim 12, the unmanned vehicle further comprising:
a motor controller contained within the housing, the motor controller coupled to the motor.

18. The unmanned vehicle of claim 12, wherein:
said housing comprises removable bottom cover wherein the removable bottom cover comprises said mounting holes.

19. The unmanned vehicle of claim 18, wherein:
said removable bottom cover comprises a notch, said light-transparent piece covering the notch, wherein the notch permits light from the light source to exit the one end of the housing.

20. The unmanned vehicle of claim 19, wherein:
the notch has a width of at least 45 degrees of the circumference of the removable bottom cover and the housing.

21. The unmanned vehicle of claim 19, wherein:
the notch has a width of at least 80 degrees of the circumference of the removable bottom cover and the housing.

22. The unmanned vehicle of claim 12, wherein:
said light-transparent piece comprises a portion co-planar with the one end of the housing.

23. A method of manufacturing a motor unit system, the method comprising:
providing a housing comprising a circular cross-section and further comprising a plurality of mounting holes on one end of the housing;
providing a brushless direct current motor comprising a shaft and a winding, the shaft extending from inside the housing to outside of the housing through a hole at the one end of the housing or at another end of the housing, the other end of the housing being opposite the one end of the housing, the winding being contained within the housing;
providing a light source contained within the housing; and
providing an opening adapted to allow light from the light source to exit the housing.

24. The method of claim 23, the method further comprising:
providing a light-transmissive piece positioned in the opening comprising a portion continuous with the circular cross-section; and
wherein the light source is optically coupled to the light-transmissive piece.

25. The method of claim 24, the method further comprising:
providing a light control contained within the housing, the light control coupled to the light source and to a connector adapted to connect the light control to an external controller to receive control signals from outside the housing from the external controller.

26. The method of claim 25, wherein:
said light source is adapted to produce a first light color in response to a first signal from said light control and is adapted to produce a second light color in response to a second signal from said light control.

27. The method of claim 25, wherein:
said light source is adapted to produce a first blinking pattern in response to a first signal from said light control and is adapted to produce continuous light in response to a second signal from said light control.

28. The method of claim 23, the method further comprising:
providing a motor controller contained within the housing, the motor controller coupled to the motor.

29. The method of claim 23, wherein:
said housing comprises removable bottom cover wherein the removable bottom cover comprises said mounting holes.

30. The method of claim 29, wherein:
said removable bottom cover comprises a notch, said light-transparent piece covering the notch, wherein the notch permits light from the light source to exit the one end of the housing.

31. The method of claim 30, wherein:
the notch has a width of at least 45 degrees of the circumference of the removable bottom cover and the housing.

32. The method of claim 30, wherein:
the notch has a width of at least 80 degrees of the circumference of the removable bottom cover and the housing.

33. The method of claim 23, wherein:
said light-transparent piece comprises a portion co-planar with the one end of the housing.
